(19) United States
(12) Patent Application Publication
(10) Pub. No.: US 2007/0050992 A1
(43) Pub. Date: Mar. 8, 2007

(54) System and apparatus for attaching an electric motor to a power tool

(76) Inventor: David B. Fisher, Bowling Green, KY (US)

Correspondence Address: MIDDLETON & REUTLINGER, 2500 BROWN & WILLIAMSON TOWER, LOUISVILLE, KY, 40202, US

(21) Appl. No.: 11/220,178

(22) Filed: Sep. 6, 2005

(51) Int. Cl. B27B 17/00

(52) U.S. Cl. 30/381

(57) ABSTRACT

A mounting system for securing a motor to a tool chassis comprises a mounting recess within said tool chassis having a plurality of engagement tabs extending into said mounting recess and a motor casing having a plurality of grooves therein that are shaped to be engaged by the plurality of engagement tabs.

### FIELD OF THE INVENTION

The present invention relates generally to electric power operated hand tools and specifically to an improved apparatus and method for securing an electric motor to a power tool.

### BACKGROUND OF THE INVENTION

Lightweight and portable power tools have become popular consumer items as the number of people who own and maintain their own homes has grown over the past decades. Specifically, lightweight electrically powered chainsaws, hedge trimmers, edgers, weed trimmers and similar electrical power tools have proliferated due to the need for light tree and branch trimming and the widespread commercialization of consumer-grade tools. Electrically powered hand tools are preferred by many consumers over conventional two-cycle motor type saws since they obviate the need for mixing oil and gas as required for most two-cycle systems, are much quieter to use, and are usually lighter in weight.

Manufacturers of electrically powered hand tools typically purchase or produce separate armatures (rotors) and stators and then assemble these components together to produce an electric motor as an integral step in the assembly process. One disadvantage to this assembly process is that there is no convenient point at which to test the motor for proper operation individually prior to completion of the finished product. Accordingly, if a motor is proven to be defective the entire tool must typically be disassembled to repair or replace the defective motor. Of course this trial and error method of product testing and repair is quite labor intensive and therefore costly.

Additionally, those manufacturers choosing to purchase electric motor components rather than produce them directly most often must purchase these components from a foreign manufacturer, since a large percentage of electric motors are presently produced overseas. Unfortunately, this means that lead times for procurement of these motors can be quite long, thereby compounding the difficulty of replacing a defective motor.

Furthermore, the process of assembling an individual armature and stator is quite labor intensive, requiring many fasteners and the concomitant labor required to secure the motor within the enclosure or chassis of an individual tool. Additionally, since most tool chassis designs are different, the attachment points for motors change dramatically depending upon the application, even where the specifications of the motor are identical. Accordingly, motor housings come in a wide variety of shapes and sizes even where the internal motor components are the same.

As a further consideration, replacing or repairing a defective motor or motor part for a consumer in these prior art devices is a fairly daunting task, even when the part to be repaired is relatively simple, because of all the hardware involved and the necessity of maintaining proper alignment of the motor within the housing and chassis of the tool. In positioning the motor, it is essential that the alignment and position of the motor output shaft with a driven member of the tool be accurate. Furthermore, the motor must be secured to the chassis with sufficient force to withstand the rigors of repeated use and the occasional impact such tools are subjected to, as well as the ability to overcome the rotational inertia generated by the motor when operating.

Many prior art motors are produced and sold with integral housings. Such “canned” motors are typically used in stationary equipment and usually come in a plurality of standardized sizes and standardized mounting configurations. These motors are not typically used in hand-held power tools due to the tremendous variety of such tools and the widely varying mounting and performance specifications necessary to adapt such motors to use in hand-held applications.

Accordingly, there is a need in the art for a system of attaching a standardized motor and enclosure to a hand-held power tool wherein the motor may be readily removed and replaced when necessary. There is also a need for a system of securing an electric motor to a power tool that permits a single mounting configuration to be used both for a wide variety of power tools and a wide variety of motor sizes.

### SUMMARY OF THE INVENTION

In order to obviate the above-mentioned problems, a power tool is provided that having an attachment system for mounting an electric motor securely thereto that obviates the need for complex fastening systems or the necessity of producing each motor from its component parts.

Several criteria exist for the satisfactory attachment of an electric motor to a hand-held power tool. Initially, the motor's output shaft must be properly aligned with a driven member of the tool to avoid stress to both motor and drive train. Secondly the motor must be held securely to the tool to withstand its intended use. Thirdly the attachment system must be able to withstand the rotational inertia generated by the motor. Finally, there must exist a means to prevent inadvertent disengagement of the motor from the chassis of the tool.

Accordingly, the present invention provides a power tool that comprises a mounting recess that is positioned within the power tool chassis. The mounting recess is shaped to accept an exterior casing of an electric motor therein and can be formed in a generally annular shape. The mounting recess further includes a plurality of tabs or similar protrusions that extend inwardly and that are shaped to be accepted by a plurality of partially circumferential grooves that are recessed within an outer casing of an electric motor.

The motor casing may further include a plurality of tab recesses that permit the motor to be axially inserted into the chassis mounting recess, then rotated so that the tabs in the mounting recess engage the grooves in the motor casing. The present invention may further include an alignment aperture disposed in the mounting recess, and a complementary alignment boss protruding from an end of the motor casing to ensure proper alignment and positioning of the motor within the mounting recess.

Other features, objects and advantages of the present invention will become apparent from reading the detailed description of the preferred embodiments taken in conjunction with the attached drawing Figures.

### BRIEF DESCRIPTION OF THE DRAWING FIGURES

FIG. 1 is a left side view of an electric chain saw power tool in accordance with one embodiment of the present invention.

FIG. 2 is a partial left side view of an electric chain saw power tool chassis in accordance with one embodiment of the present invention.

FIG. 3 is an isometric view of an electric motor in accordance with one embodiment of the present invention.

FIG. 4 is a side view of an electric chain motor in accordance with one embodiment of the present invention.

FIG. 5 is an isometric view of an electric motor being inserted into a chassis mounting recess in accordance with one embodiment of the present invention.

FIG. 6 is a partial left side view of an electric chain saw power tool chassis in accordance with one embodiment of the present invention.

FIG. 7 is an isometric view of an electric motor in accordance with one embodiment of the present invention.

FIG. 8 is an isometric view of an electric motor in accordance with one embodiment of the present invention.

FIG. 9 is a partial left side view of an electric chain saw power tool chassis in accordance with one embodiment of the present invention.

### DETAILED DESCRIPTION OF THE PREFERRED EMBODIMENT(S)

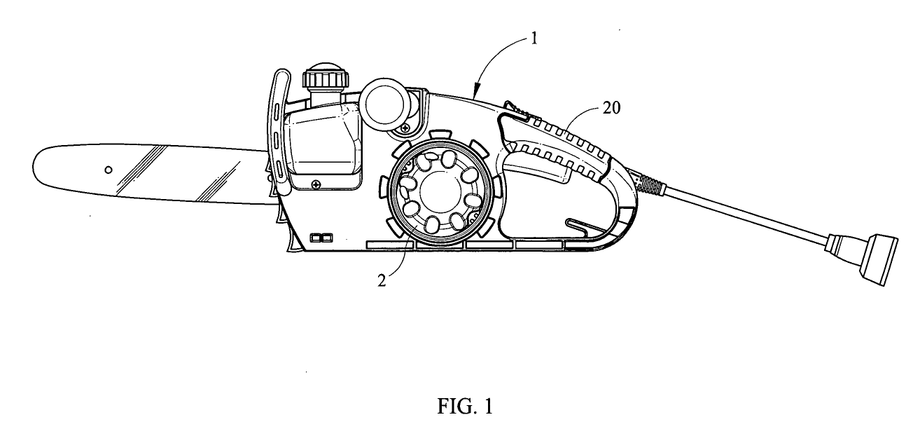

Referring now to FIG. 1, and in accordance with a preferred constructed embodiment of the present invention, a mounting system 10 and method for securing a motor 2 to a motor-driven power tool 1 chassis 20 comprises a mounting recess 30 positioned in said chassis 20 to receive a casing exterior or enclosure 60 of motor 2. Mounting recess 30 comprises a plurality of engagement tabs 32 extending radially inwardly from annular alignment flange 34 that may either extend outwardly away from a side 22 of chassis 20, or alternatively extend inwardly into side 22. In one embodiment of the present invention, engagement tabs 32 are arcuate in shape. While alignment flange 34 is shown to be generally annular in construction, it may be formed in a wide variety of shapes and sizes depending upon the shape and size of mounting end 62 of motor enclosure 60.

Mounting recess 30 may further include an alignment aperture 36 extending through chassis 20 and a motor lead aperture 37 that permits the routing of a motor lead or leads 64 therethrough, for access to electrical connections (now shown) required to provide electrical power to motor 2. Additionally, mounting recess 30 may comprise an aperture 40 through which a fastener such as a screw may be inserted to effect retention of motor enclosure 60 in mounting recess 30. In this embodiment of the invention, a screw is inserted into aperture 40 on the opposite side of chassis 20 from mounting recess 30, whereby the screw contacts mounting end 62 of motor casing 60 to prevent the rotational movement thereof once it is securely seated within mounting recess 30.

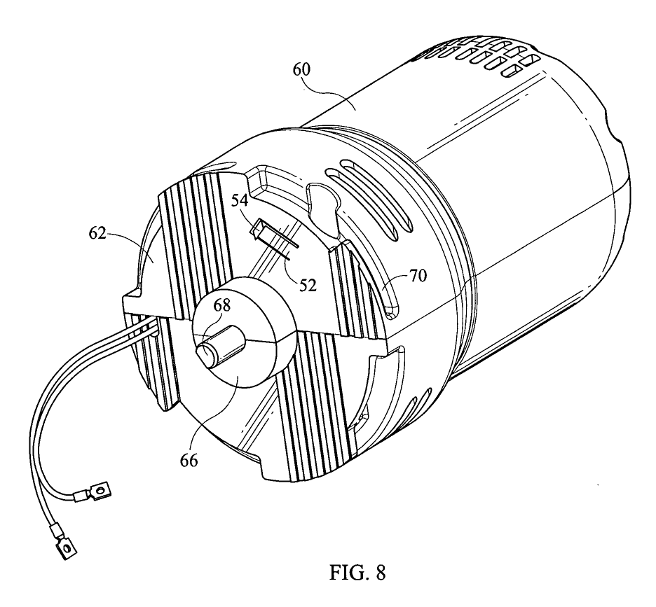

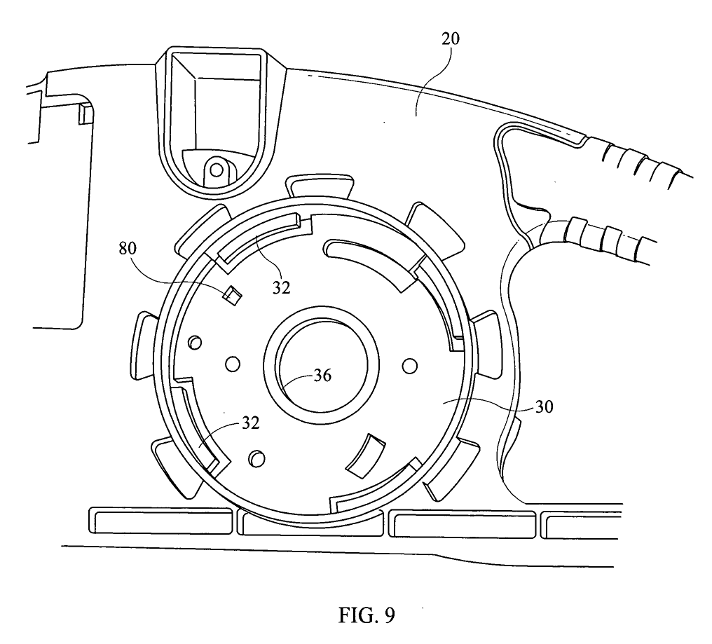

While aperture 40 and a concomitant fastener are a simple and effective retaining means 50 for prohibiting relative rotation of motor 2 and chassis 20 once they are properly positioned, a plurality of alternative retaining means may be employed. As best seen in FIGS. 8 and 9 motor casing 60 may further comprises a leaf spring 52 having a catch tab 54 positioned on a free end thereof that is biased slightly outwardly from mounting end 62 of motor casing 60. Mounting recess 30 includes a retention aperture 80 that is shaped to engage catch tab 54 once motor 2 is rotated to a point where retention aperture 80 and catch tab 54 align. This feature of the present invention facilitates proper positioning of motor 2 and chassis 20 relative to each other and provides a positive and automatic retention of motor 2 within recess 30, thereby obviating the need for additional fasteners and parts.

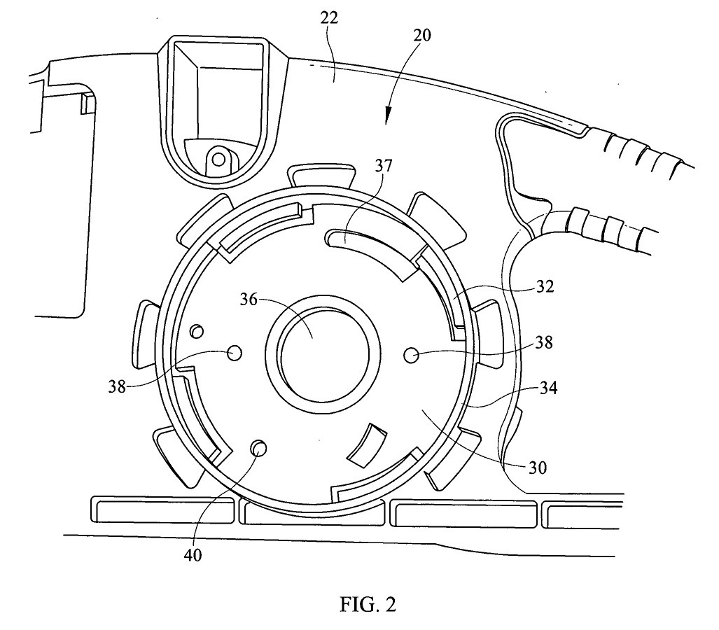

Mounting recess 30 may further comprise a means for biasing motor 2 outwardly away from chassis 20. As best seen in FIG. 2 the means for biasing motor 2 may comprise a dimple or dimples 38 extending outwardly from mounting recess 30, said dimples capable of biasing a mounting end 62 of motor casing 60 outwardly, away from mounting recess 30 for reasons that will be explained herein below. Alternatively, the means for biasing motor 2 may comprise a leaf or coil spring, or other spring means disposed within mounting recess 30.

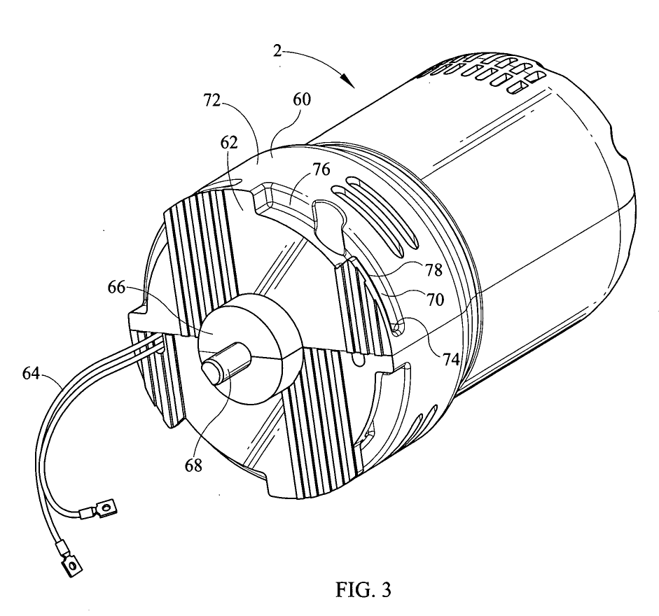

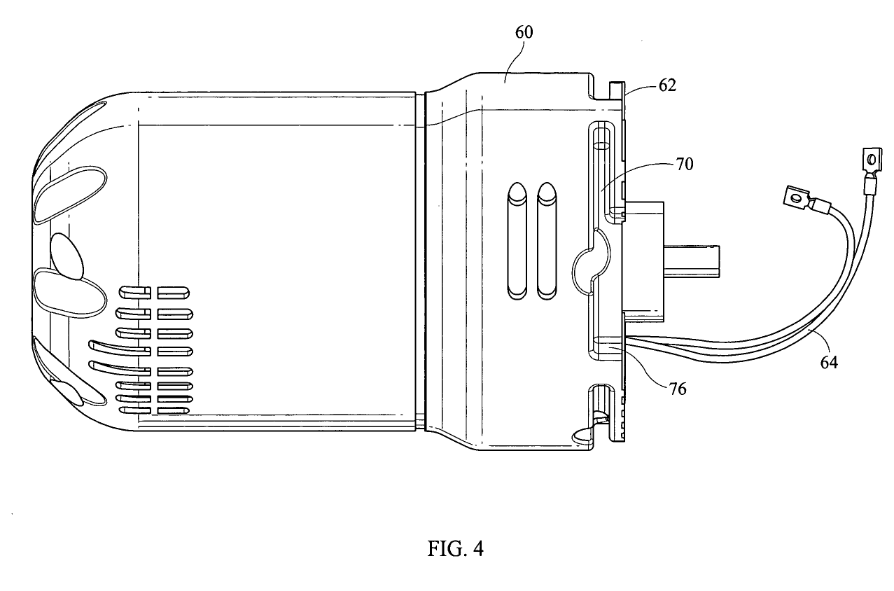

Referring now to drawing FIGS. 3 and 4 and in accordance with one embodiment of the present invention 10, motor 2 comprises an exterior casing 60 having a mounting end or face 62 that extends into mounting recess 30. A plurality of motor leads 64 extend outwardly from mounting end 62 and may be advantageously routed through motor lead aperture 37 whereupon they may be connected to a source of electrical power (not shown). It should be noted that motor leads 64 may exit motor casing 60 at a plurality of different points depending upon motor 2 design, and are not required to be routed through motor lead aperture 36 prior to termination.

Mounting end 62 of motor casing 60 further comprises an alignment boss 66 extending therefrom, through which output shaft 68 of motor 2 passes. Alignment boss 66 is shaped to closely engage alignment aperture 36 to thereby positively positioning mounting end 62 of motor casing 60 in mounting recess 30 and providing for proper shaft 68 position relative a drive mechanism of power tool 1, for example a sprocket or the like. As depicted in FIGS. 2 and 3 alignment aperture 36 is generally circular in shape and alignment boss 66 is generally annular in construction. However, one of ordinary skill in the art will recognize that any of a wide variety of mating shapes may be employed for alignment aperture 36 and complementary alignment boss 66, without departing from the scope of the instant invention.

Motor casing 62 further comprises a plurality of grooves 70, shown in FIG. 3 as recessed in an exterior surface 72. Grooves 70 may extend circumferentially around a portion of motor casing 60 proximate the mounting end 62 and may include a closed end 74 that is designed to abut engagement tab 32 once motor casing 60 is securely in place within mounting recess 30.

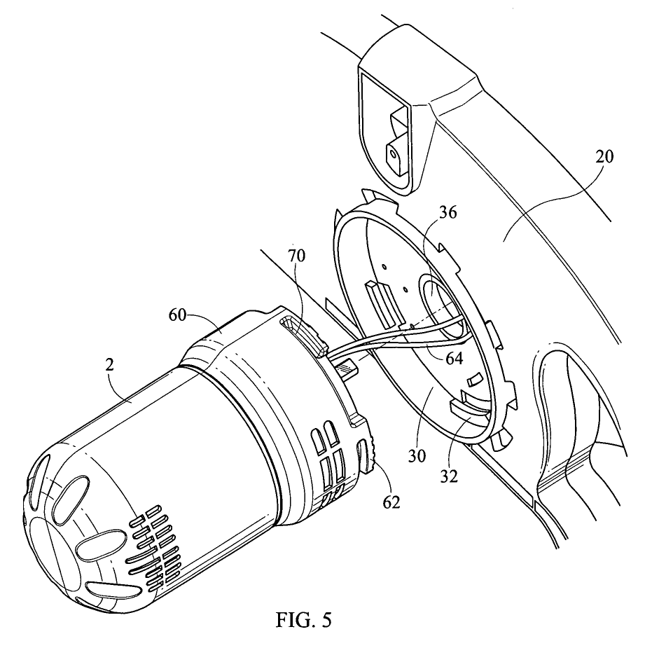

Furthermore, motor casing 60 can comprise a plurality of tab alignment slots 76 adjacent each of the plurality of grooves 70 and generally aligned therewith around the circumference of motor casing 60 proximate mounting end 62. Tab alignment slots 76 serve to accept engagement tabs 32 as motor 2 is inserted axially into mounting recess 30. Once so inserted, motor 2 is simply rotated clockwise, as shown in FIG. 5, such that engagement tabs 32 rotate into and engage grooves 70 until tabs 32 contact closed ends 74 of grooves 70.

As motor 2 is inserted and rotated into position as described above, dimples 38 contact mounting end 62 of motor casing 60 thereby providing a force against which motor 2 must be rotated. Stated another way, dimples 38 act to position motor casing 60 axially away from mounting recess 30 such that engagement tabs 32 slightly interfere with a forward surface 78 of grooves 70. This feature of the invention requires that a certain amount of compressive force be necessary to positively engage grooves 70 with tabs 32 thereby allowing the motor to remain securely in place even when the rotational inertia of the motor armature acts against it.

In an alternative embodiment of the present invention, the plurality of engagement tabs 32 are oriented at an angle with respect to the plurality of grooves 70 in said motor casing 60 thereby causing a slight interference fit between tabs 32 and grooves 70. In other words, a central longitudinal axis of engagement tab 32 may be positioned at an angle with respect to a central longitudinal axis of groove 70. This embodiment of the present invention causes compressive engagement of motor casing 60 and said chassis 20 when the plurality of tabs 32 engage the plurality of grooves 70, thereby inhibiting rotation of motor 2 that may be caused by the rotational inertia of the motor.

In a yet further embodiment of the present invention, the plurality of engagement tabs 32 and the plurality of grooves 70 may be positioned with their central axes oriented in substantially the same direction, but at an angle with respect to the mounting end 62 such that the grooves 70 travel an approximately helical path around the exterior 72 of motor casing 60, while 32 tabs are arranged in a complementary fashion in mounting recess 30. This feature of the present invention provides a screw-type fastening of motor 2 to chassis 20.

While reference has been consistently made throughout this specification to a mounting recess 30 having engagement tabs and complementary grooves 70 in motor casing 60, one of ordinary skill in the art will recognize that the present invention may be employed as a system to connect any two components wherein a first component includes a mounting recess 30 having engagement tabs 32 depending therefrom while a second component includes a surface or surfaces having complementary grooves 70 therein that are engaged by tabs 32 as described herein above.

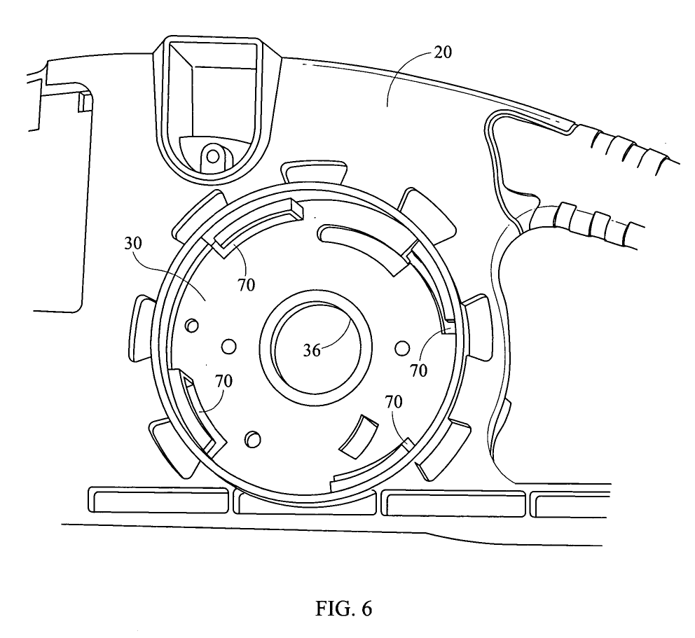

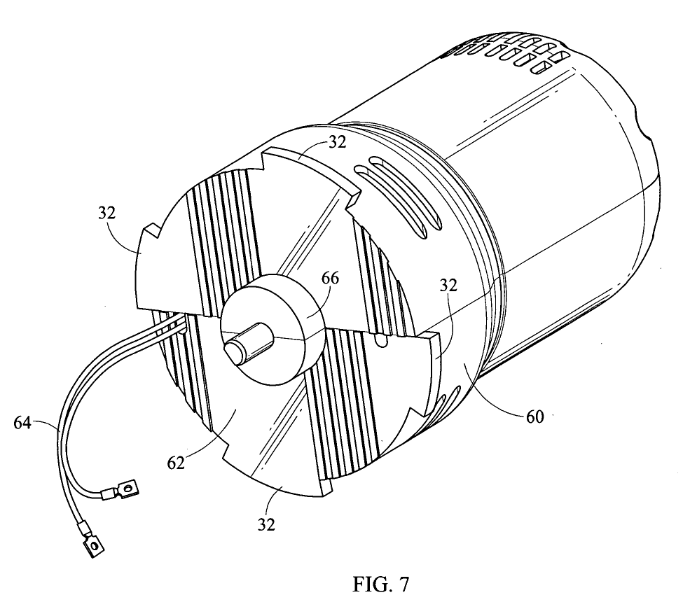

Furthermore, and in accordance with an alternative embodiment of the present invention, a system for connecting two components may be constructed wherein a first component includes a mounting recess 30 having a plurality of grooves 70 therein while a second component may include a mating surface having a plurality of complementary engagement tabs 32 depending therefrom that engage grooves 70 when the mating surface is inserted axially into mounting recess 30 and rotated relative thereto. This embodiment of the present invention is best seen in FIGS. 6 and 7.

While the present invention has been shown and described herein in what are considered to be the preferred embodiments thereof, illustrating the results and advantages over the prior art obtained through the present invention, the invention is not limited to those specific embodiments. The forms of the invention shown and described herein are to be taken as illustrative only and other embodiments may be selected without departing from the scope of the present invention, as set forth in the claims appended hereto.

We claim:

1. A mounting system for securing together first and second components comprising:
a mounting recess having a plurality of engagement tabs depending therefrom; and
a mating surface having a plurality of complementary grooves therein shaped to be engaged by the engagement tabs.

2. A mounting system as claimed in claim 1 wherein said mounting recess is integral to said first component and wherein said mating surface is integral to said second component.

3. A mounting system as claimed in claim 2 wherein the plurality of grooves are engaged by the plurality of tabs through relative rotation of said components.

4. A mounting system as claimed in claim 2 wherein the grooves further comprise a closed end that abuts the plurality of engagement tabs thereby preventing rotation of said mating surface.

5. A mounting system as claimed in claim 2 wherein the grooves in said mating surface are circumferentially oriented around an exterior thereof.

6. A mounting system as claimed in claim 2 further comprising:
a plurality of tab alignment slots in said mating surface adjacent said plurality of grooves wherein the plurality of engagement tabs of said mounting recess are received by the plurality of tab alignment slots as said mating surface is axially inserted in said mounting recess.

7. A mounting system as claimed in claim 1 wherein the plurality of engagement tabs and the plurality of grooves are semi-circular.

8. A mounting system as claimed in claim 2 wherein the plurality of tabs are oriented at an angle with respect to the plurality of grooves in said mating surface thereby causing compressive engagement of first and second components when the plurality of tabs engage the plurality of grooves.

9. A mounting system as claimed in claim 1 wherein said mounting recess is disposed in a power tool chassis and said mating surface is integral to a motor casing.

10. A mounting system as claimed in claim 1 wherein said mounting recess is disposed in a mounting end of a motor casing and said mating surface is integral to a power tool chassis.

11. A mounting system for securing together first and second components comprising:
a mating surface having a plurality of engagement tabs depending therefrom; and
a mounting recess having a plurality of complementary grooves therein shaped to be engaged by the engagement tabs.

12. A mounting system as claimed in claim 11 wherein said mounting recess is integral to said first component and wherein said mating surface is integral to said second component.

13. A mounting system as claimed in claim 12 wherein the plurality of grooves are engaged by the plurality of tabs through relative rotation of said components.

14. A mounting system as claimed in claim 12 wherein the plurality of grooves further comprise a closed end that abuts the plurality of engagement tabs thereby preventing rotation of said mating surface relative to said mounting recess.

15. A mounting system as claimed in claim 12 wherein the engagement tabs depending from said mating surface are circumferentially oriented around an exterior thereof.

16. A mounting system as claimed in claim 12 further comprising:
a plurality of tab alignment slots in said mating mounting recess adjacent said plurality of grooves wherein the plurality of engagement tabs of said mating surface are received by the plurality of tab alignment slots as said mating surface is axially inserted in said mounting recess.

17. A mounting system as claimed in claim 11 wherein the plurality of engagement tabs and the plurality of grooves are semi-circular.

18. A mounting system as claimed in claim 12 wherein the plurality of tabs are oriented at an angle with respect to the plurality of grooves in said mounting recess thereby causing compressive engagement of first and second components when the plurality of tabs engage the plurality of grooves.

19. A mounting system as claimed in claim 11 wherein said mounting recess is disposed in a power tool chassis and said mating surface is integral to a motor casing.

20. A mounting system as claimed in claim 11 wherein said mounting recess is disposed in a mounting end of a motor casing and said mating surface is integral to a power tool chassis.

21. A mounting system for securing a motor to a tool chassis comprising:
a mounting recess within said tool chassis having a plurality of engagement tabs extending into said mounting recess; and
a motor casing enclosing said motor having a plurality of grooves therein that are shaped to be engaged by the plurality of engagement tabs.

22. A mounting system for securing a motor to a tool chassis as claimed in claim 21 wherein the plurality of grooves are engaged by the plurality of tabs through rotation of said motor casing.

23. A mounting system for securing a motor to a motor-driven tool chassis as claimed in claim 21 wherein the plurality of grooves in said motor casing comprise a closed end that abuts the plurality of engagement tabs thereby preventing rotation of said motor casing.

24. A mounting system for securing a motor to a tool chassis as claimed in claim 21 wherein the grooves in said motor casing are circumferentially oriented around the exterior of said motor casing proximate a mounting end thereof.

25. A mounting system for securing a motor to a tool chassis as claimed in claim 21 wherein the engagement tabs are arcuate in shape.

26. A mounting system for securing a motor to a tool chassis as claimed in claim 21 further comprising:
an alignment aperture in said mounting recess through which a drive shaft of said motor passes.

27. A mounting system for securing a motor to a tool chassis as claimed in claim 26 further comprising:
a shaft alignment boss protruding from the mounting end of said motor casing, wherein the alignment boss engages the alignment aperture of said mounting recess as said motor is axially inserted therein.

28. A mounting system for securing a motor to a tool chassis as claimed in claim 21 further comprising:
a plurality of tab alignment slots in said motor casing adjacent said plurality of grooves wherein the plurality of engagement tabs of said mounting recess are received by the plurality of tab alignment slots as said motor is axially inserted in said mounting recess.

29. A mounting system for securing a motor to a tool chassis as claimed in claim 21 wherein the plurality of engagement tabs and the plurality of grooves are semi-circular.

30. A mounting system for securing a motor to a tool chassis as claimed in claim 21 further comprising:
a motor lead aperture in said mounting recess for routing a motor lead therethrough.

31. A mounting system for securing a motor to a tool chassis as claimed in claim 21 further comprising:
a retaining means for preventing rotation of said motor casing within said mounting recess.

32. A mounting system for securing a motor to a tool chassis as claimed in claim 21 wherein the plurality of tabs are oriented at an angle with respect to the plurality of grooves in said motor casing thereby causing compressive engagement of said motor casing and said chassis when the plurality of tabs engage the plurality of grooves.

33. A mounting system for securing a motor to a tool chassis as claimed in claim 21 further comprising:
a plurality of dimples extending outwardly from said mounting recess toward the mounting end of said motor casing to provide a compressive force against the engagement of said motor casing and said mounting recess.

34. A mounting system for securing a motor to a tool chassis as claimed in claim 21 further comprising:
a plurality of springs extending outwardly from said mounting recess toward the mounting end of said motor casing to provide a compressive force against the engagement of said motor casing and said mounting recess.

35. A mounting system for securing a motor to a tool chassis as claimed in claim 12 further comprising:
a means for retaining said motor casing within said mounting recess.

36. A mounting system for securing a motor to a tool chassis as claimed in claim 35 wherein said means for retaining said motor casing comprises an aperture within said mounting recess and a screw inserted therethrough that engages the mounting end of said motor casing.

37. A mounting system for securing a motor to a tool chassis comprising:
an alignment flange extending outwardly from said chassis having a plurality of tabs extending radially inwardly therefrom; and
a motor casing having a plurality of grooves therein that are engaged by the plurality of tabs.

38. A mounting system for securing a motor to a tool chassis as claimed in claim 37 wherein said alignment flange is annular.

39. A mounting system for securing a motor to a tool chassis as claimed in claim 37 further comprising:
a plurality of tab alignment slots in said motor casing adjacent said plurality of grooves wherein the plurality of engagement tabs of said mounting recess are received by the plurality of tab alignment slots as said motor is axially inserted in said mounting recess.

40. A mounting system for securing a motor to a tool chassis as claimed in claim 37 wherein the plurality of tabs further comprise a central longitudinal axis oriented at an angle with respect to a central longitudinal axis of the plurality of grooves thereby causing an interference fit therebetween.
